(19) United States
(12) Patent Application Publication
(10) Pub. No.: US 2024/0280683 A1
(43) Pub. Date: Aug. 22, 2024

(54) AN APPARATUS FOR CONFIGURING RADIOFREQUENCY SENSING

(71) Applicant: SIGNIFY HOLDING B.V., EINDHOVEN (NL)

(72) Inventors: HENDRIK STEVENS, WAALRE (NL); PETER DEIXLER, ARLINGTON, MA (US); HUGO JOSÉ KRAJNC, EINDHOVEN (NL); LEENDERT TEUNIS ROZENDAAL, VALKENSWAARD (NL)

(21) Appl. No.: 18/577,740

(22) PCT Filed: Jul. 1, 2022
(86) PCT No.: PCT/EP2022/068237

§ 371 Date: Jan. 9, 2024

Related U.S. Application Data
(60) Provisional application No. 63/219,887, filed on Jul. 9, 2021.

(30) Foreign Application Priority Data
Jul. 20, 2021 (EP) 21186740.3

(51) Int. Cl. G01S 13/56; G01S 7/00; G01S 13/88

(52) U.S. Cl. CPC G01S 13/56; G01S 7/006; G01S 13/886

(57) ABSTRACT

The invention refers to an apparatus (130) for configuring a radiofrequency sensing of a radiofrequency sensing network (100) comprising network devices (121, 122, 123), e.g. luminaires, wherein the network is adapted to perform radiofrequency sensing in a first (101, 201 301) and second area (102, 202,. 302) separated by a physical separation (126, 330). The apparatus comprises a providing unit (131) determining a first baseline and a second baseline, wherein the first/second baseline is associated with the first/second area, respectively. The first/second baseline enable a radiofrequency sensing of events in the second area by the network devices. A configuration unit (132) is adapted to configure the radiofrequency sensing to differentiate between events originating from the areas based on the baselines. This allows the present invention to provide an apparatus that allows for a more accurate and reliable 10 radiofrequency sensing in a predefined sensing area.

### FIELD OF THE INVENTION

The invention relates to an apparatus, a method and a computer program product for configuring a radiofrequency sensing of a radiofrequency sensing network. Further, the invention relates to a network comprising a system for configuring a radiofrequency sensing of the radiofrequency sensing network.

### BACKGROUND OF THE INVENTION

Radiofrequency sensing is today often used for detecting an occupancy of an area using network devices with a radiofrequency capability. Generally, in most applications one is only interested in the motion or in changes that occur in a respectively configured sensing area. However, radiofrequency signals can also be effected by events occurring outside of the respectively configured sensing area even if the configured sensing area is confined, for instance, by walls, due to the possibility of radiofrequency sensing signals going through obstacles or confinements, like walls. The interaction of the radiofrequency signals with subjects present outside of the configured sensing area can lead to inaccuracies in the detection result within the configured sensing area, for instance, can lead to false positive detection results.

It would thus be advantageous to provide a radiofrequency sensing system that allows for a more accurate and reliable radiofrequency sensing even in cases in which the radiofrequency signals can interact with subjects outside of a preconfigured sensing area.

US 2014/200856 A1 discloses device-free motion detection and presence detection within an area of interest. A plurality of nodes, configured to be arranged around the area of interest, form a wireless network. The plurality of nodes transmits wireless signals as radio waves and receive transmitted wireless signals. The received signal strength (RSS) of the transmitted wireless signals between the plurality of nodes are measured and a value is reported. A computing device receives the reported values for the measured RSS and tracks the reported values over time. The computing device processes the reported values using an aggregate disturbance calculation to detect motion and presence within the area of interest.

### SUMMARY OF THE INVENTION

It is an object of the present invention to provide an apparatus, a network, a method and a computer program product that allow for a more accurate and reliable radiofrequency sensing in a predefined sensing area.

In a first aspect of the present invention an apparatus for configuring a radiofrequency sensing of a radiofrequency sensing network comprising one or more network devices configured to perform radiofrequency sensing is presented, wherein the network is adapted to perform radiofrequency sensing in a first sensing area and a second sensing area separated by at least one physical separation, wherein the apparatus comprises a) a baseline determining unit for determining a first baseline and a second baseline, wherein the first and the second baselines are determined based on radiofrequency signals received by one or more network devices of the network, and wherein the first baseline is associated with the first sensing area and wherein the second baseline is associated with the second area and is determined such that it enables a radiofrequency sensing of events in the second sensing area by the network devices, b) a configuration unit adapted to configure the radiofrequency sensing of the network devices to differentiate between events originating from the first and second sensing area based on the first baseline and the second baseline.

Since the first and the second baseline are provided, wherein the first baseline is associated with the first sensing area and the second baseline is associated with the second sensing area and since the configuration unit is adapted to configure the radiofrequency sensing of the network devices to differentiate between events originating from the first and second sensing areas based on the first baseline and the second baseline, events belonging to the first sensing area and events belonging to the second sensing area can be clearly be distinguished. Thus, false positive or false negative detections of events in one of the areas that are caused by an event in the other area can be avoided and the accuracy and reliability of the radiofrequency sensing in both sensing areas can be increased.

The apparatus is adapted to configure a radiofrequency sensing of a radiofrequency sensing network. The radiofrequency sensing network comprises one or more network devices that are configured to perform radiofrequency sensing. Generally, the network is formed by the one or more network devices, in particular, by communication between the one or more network devices. The network can be a wired network or a wireless network. Accordingly, the communication forming the network can be a wired or a wireless communication. The network communication of the network devices forming the network can be performed utilizing any known network protocol, for instance, WiFi, ZigBee, Bluetooth, IEEE 802.11 or any other wired or wireless communication protocol. Preferably, standardized communication protocols are used for the network communication of the radio frequency sensing network, e.g. protocols provided by IEEE or 3GPP. The network devices can refer to any device comprising a network capability, i.e. provide the possibility to wired or wirelessly communicate with other network devices using a network communication protocol. In a preferred embodiment, the network devices are smart home devices and the network is part of a smart home system. Generally, a smart home device can be regarded as a device providing, in addition to a primary functionality of the device, a communication function that allows the smart home device to communicate with other smart home devices and to form networks. Preferably, at least some of the network devices are smart lighting devices that comprise-in addition to their primary lighting functionality-a communication functionality that allows the network devices to form networks.

The radiofrequency sensing network is configured to perform radiofrequency sensing utilizing one or more of the network devices. In particular, at least some of the network devices forming the network comprise a radiofrequency sensing capability, in particular, are configured to transmit and/or receive radiofrequency signals and to participate in an analysis of the radiofrequency signals to generate a radiofrequency sensing result. In this context, the participation of the network devices and the analysis of the radiofrequency sensing signals can simply refer to providing sensed radiofrequency sensing signals to a device that is adapted to utilize a radiofrequency sensing algorithm for calculating a radiofrequency sensing result. However, the participation can also refer to performing such a calculation or at least part of such a calculation. Generally, the network is adapted to perform the radiofrequency sensing in a first sensing area and in a second sensing area, wherein the first sensing area and the second sensing area are separated by at least one physical separation. Generally, the two sensing areas can have any form and can refer to predefined sensing areas or can be defined based on where a radiofrequency sensing using the network devices of the radiofrequency sensing network can generally be performed. The first and the second sensing area can have any form and any spatial relation to each other as long as at least one physical separation separates the first and the second sensing area. For example, the first sensing area can refer to a room confined by walls and the second sensing area can refer to an area outside of one side of the room, for instance, can refer to a garden or a doorway. Generally, the physical separation between the first and second sensing area can refer to any separation comprising an extend that can lead to an influence on the radiofrequency sensing of the radiofrequency sensing network. In particular, the separation can influence the radiofrequency signals of the radiofrequency sensing of the radiofrequency sensing network. Generally, the physical separation is such that it separates the first and the second sensing area at least for a predetermined time period. For example, the physical separation can be a fixed physical separation, like a wall, a fence, a window; etc. or can also refer to a generally removable physical separation, like furniture, for instance, a wardrobe, flexible walls, or other room separators that allow a removal or spatial change of the room separation. Moreover, the physical separation does not have to separate the first and second sensing areas completely, for instance, the physical separation might not have the same height as a room in which the physical separation is provided such that the first sensing area and the second sensing area defined on either side of the physical separation in the room are not completely separated by the physical separation due to the space left between the physical separation and the ceiling of the room. However, it is preferred that the physical separation extends at least over a major part of the area between the first and the second sensing area.

The first and the second sensing areas can be defined, for instance, by the positions of the network devices and by a radiofrequency sensing range of the network devices such that the first and the second sensing area can be defined by a radiofrequency coverage provided by the network devices. Preferably, the first and second sensing area is defined such that all network devices of the network are positioned on the side of the physical separation of the first sensing area. In this case radiofrequency signals received from the second sending area refer at least partly to signals that have interacted with the physical separation. However, in some embodiments, the first and second sensing area can also be defined such that some of the network devices are also positioned on the side of the physical separation of the second sensing area. In this case also the signals received in the second sensing area have at least partly interacted with the physical separation.

The baseline determining unit is adapted to determine a first baseline and a second baseline based on based on radiofrequency signals received by one or more network devices of the network. For instance, the received radiofrequency signals can be stored on a storage unit and the baseline determining unit can be adapted to access the storage unit and retrieve the radiofrequency signals for determining the baselines. However, the baseline determining unit can also be directly connected to at least one of the network devices to receive the radiofrequency signals for determining the baselines.

Generally, a baseline can refer to a radiofrequency signal or to one or more characteristics of a radiofrequency signal that are used as a reference with respect to later determined radiofrequency signals, wherein based on the difference a radiofrequency sensing result is determined. A baseline can refer to radiofrequency signals or to one or more characteristics of radiofrequency signals that are used as a reference with respect to later determined radiofrequency signals, wherein based on the difference a radiofrequency sensing result is determined. For example, a baseline can be determined such that it is indicative of a known physical state of an area for which the baseline is determined. For example, the known physical state of an area can refer to the known presence or absence of specific subjects, for instance, one or more persons, in the area. A baseline can then be determined, for instance, by detecting radiofrequency signals provided by the network devices in the area during the known physical state of the area. The such detected radiofrequency signals can then be directly utilized as baseline, or can be further processed, for instance, by averaging, weighted averaging, filtering, etc. before being utilize as baseline. Moreover, one or more characteristics of the such detected radiofrequency signals, for instance, an average or highest or lowest amplitude of the such detected radiofrequency signals, can also be used as baseline. Preferably, the first and second baseline are determined based on the same received radiofrequency signals.

The first and the second baseline determined by the baseline determining unit are associated with the first and second sensing area, respectively. This association refers to the usability of the respective baseline for sensing an event in the respective sensing area. Accordingly, the first baseline associated with the first sensing area is determined such that a radiofrequency sensing algorithm can utilize the first baseline to determine an event occurring within the first sensing area. Accordingly, the second baseline associated with the second sensing area is determined such that a radiofrequency sensing algorithm can utilize the second baseline for determining a sensing event in the second sensing area. In particular, the first and the second baseline are determined such that the events can be detected in the first and second sensing area by utilizing the same network devices, i.e. by utilizing the same radiofrequency sensing signals. In particular, the first and the second baseline are determined based on baseline measurements performed by the same radiofrequency sensing network devices. Thus, for performing radiofrequency sensing in the first and the second sensing area the network devices are not, for instance, divided into two different network groups each performing radiofrequency sensing in the respective first and second sensing area independently. This allows for a much easier controlling and configuration of the radiofrequency sensing network.

Generally, after the first and second baseline have been determined, the baselines can be stored on a respective storage such that they can be utilized by the configuration unit. In particular, different first and second baselines can be determined and stored such that the configuration unit can select respective baselines, for instance, based on a sensing goal.

The configuration unit is adapted to configure the radiofrequency sensing of the network devices to differentiate between events originating from the first and second sensing areas based on the first baseline and the second baseline. In particular, the radiofrequency sensing is configured such that based on the first and second baseline the radiofrequency sensing is performed in the first and second sensing area in dependence on each other. This allows, via the first and second baseline, to take into account interactions of the radiofrequency signal with a subject in one area when performing radiofrequency sensing in the other area. Preferably, the configuration unit is adapted to configure the radiofrequency sensing such that the differentiation between events originating from the first and second area is based on processing instructions with respect to a processing of radiofrequency signals acquired by one of the network devices of the network during a radiofrequency sensing utilizing the first and second baseline. For example, the processing instructions can refer to rules that indicate how a radiofrequency signal should be processed by a radiofrequency sensing algorithm and how in the radiofrequency sensing algorithm the first and second baseline should be utilized. In particular, such processing instructions can be stored on a storage which can be accessed by the configuration unit together with instructions for the applicability of the respective processing instructions. For example, for different sensing goals and different first and second baselines respective different processing instructions can be stored. The configuration unit can then be adapted to implement the processing instructions to configure the radiofrequency sensing in dependency of the respective sensing goal and first and second baselines. Respective rules can be based, for instance, on the physical state in which the respective first and second baseline have been determined. Moreover, the rules can indicate how the respective radiofrequency sensing algorithm should utilize the first and second baseline with respect to currently detected radiofrequency signals of the network devices. For example, the rules can indicate that the radiofrequency sensing algorithm should first utilize the first baseline, for instance, by comparing the first baseline to the currently sensed radiofrequency signals, to determine a presence or absence in the first sensing area, wherein, if a presence is detected, the rules indicate that the radiofrequency sensing algorithm should utilize in a next step the second baseline to determine presence or absence in the second sensing area, wherein a presence detection in the second sensing area might indicate that the presence detection in the first sensing area might be a false positive detection caused by the presence of the person in the second sensing area. However, the rules might also indicate to first filter the radiofrequency signals, for instance, utilizing the second baseline, and then to utilize the first baseline together with the filtered radiofrequency signals in the radiofrequency sensing algorithm to detect an event in the first sensing area.

Generally, after the configuration unit has configured the radiofrequency sensing of the network devices, the radiofrequency sensing of the network is performed in accordance with this configuration. However, the configuration unit can be adapted to reconfigure the radiofrequency sensing of the network from time to time, for instance, based on feedback of a user, or based on newly provided first and second baselines.

In an embodiment the first baseline is determined based on radiofrequency signals received when the first sensing area and the second sensing area are both in the same state with respect to a sensing goal of the radiofrequency sensing performed by the network devices, and wherein the second baseline is determined based on radiofrequency signals received when the first sensing area and the second sensing area are in different states with respect to a sensing goal of the radiofrequency sensing performed by the network devices. A sensing goal of the radiofrequency sensing performed by the network can refer to any radiofrequency sensing goal, for instance, to a presence/absence detection of subjects in a room, to a specific activity detection of subjects in a room, to a health parameter detection of subjects in a room, to a state detection of specific objects in a room, etc. In this context, subjects refer generally to living beings, in particular, to human beings or animals. Accordingly, the same state of the respective first and second sensing area with respect to the sensing goal refers to a state in which the same detection results with respect to the sensing goal would be achieved during radiofrequency sensing. For example, if the radiofrequency sensing goal refers to presence/absence detection of subjects a same state of the first and second sensing area can be achieved if in both sensing areas a person is present, or if in both sensing areas a person is absent. Accordingly, in this example different states of the sensing areas would be achieved if in one of the sensing areas a person is present and in the other no person is absent. Utilizing a first and a second baseline that are determined as described above allows to clearly differentiate between events detected in the first sensing area and events detected in the second sensing area when applying the first and the second baseline to currently detected radiofrequency signals.

In a preferred embodiment the sensing goal refers to a presence/absence or activity detection of subjects in the first and second area, wherein the state of the first and second sensing area, when receiving the radiofrequency signals utilized for determining the first baseline, refers to a state in which subjects are absent or not active in the first and second area, respectively. Moreover, it is preferred that when the sensing goal refers to a presence/absence or activity detection of subjects in the first and second area, the state of the first and second sensing area when receiving the radiofrequency signals utilized for determining the second baseline refers to a state in which subjects are absent or inactive in the first and present or active in the second area, respectively.

In an embodiment the apparatus comprises a user interface unit, wherein the user interface unit is adapted to provide instructions to a user with respect to the performing of specified actions in the first area and the second area, wherein the first and second baseline are determined based on radiofrequency signals received by one or more of the network devices of the network when the user performs the actions indicated by the instructions. The user interface unit can be, for instance, also a device being part of the network. However, the interface unit can also be a device that is not part of the network and is for instance, only communicatively connected to, for instance, the baseline determination unit. The user interface unit can be a dedicated unit, for instance, a dedicated display, but can also be an interface unit that is also used for different purposes, for instance, a smartphone of a user, a loudspeaker, a computer display, a television display, etc. Generally, the user interface unit can refer to any kind of interface, in particular, to a visual and/or audio interface. Accordingly, the user interface unit can be adapted to provide instructions visually and/or audible to the user. The instructions can refer to any kind of instructions provided, for instance, in writing or in a symbolic way that can be interpreted by the user accordingly. In case of audible signals the instructions can be provided as speech output or as audible signals that can be interpreted by the user accordingly. The instructions can be provided in accordance, for instance, with a respective sensing goal. For example, if the sensing goal refers to a presence/absence detection the instructions can be adapted to prompt a user to be present in a specific area of the room, for instance, in the first area, for some time and then to be present in another area of the room, for instance, in a respective second area. In another example, if the sensing goal refers to an activity detection, the instructions can prompt the user to perform the respective activity, for instance, first in the first sensing area and then in the second sensing area.

Additionally or alternatively the interface unit can also be adapted to question a user with respect to a previously or currently performed activity. In this case, the first and second baseline can be determined based on radiofrequency signals that already have been received during the previously or currently performed activity. For example, the interface unit can question a user if he had previously been present in the second sensing area, for instance, in a hallway and has now entered the first sensing area, for instance, a living room. Based on the answer of the user the previously and currently received radiofrequency signals can be utilized to determine the first and second baseline.

Additionally or alternatively to the user interface unit, also a user action deriving unit can be provided, wherein the user action deriving unit is adapted to derive specific actions of a user from interaction data of the user received when the user interacts in any way with the network, i.e. with one or more of the network devices of the network. For example, if some of the network devices refer to lighting devices and the user interacts with the lighting devices by switching on the lighting devices the user action deriving unit can be adapted to derive as a user action that the user is currently present in the room in which the lights have been turned on, whereas if the lights are turned off the user action deriving unit can be adapted to derive as current user action that the user is absent from the room in which the lights have been turned off. The first and second baseline can then be determined based on radiofrequency signals that have been received when the user action deriving unit has derived a respective user action in the first and/or second sensing area referring to the respective sensing goal. Moreover, the user action deriving unit can be adapted to utilize, additionally or alternatively to the user interaction data, environmental data for deriving a user action. For example, the environmental data can refer to a current time of day, a current state of an alarm system, a current state of a door lock, a current date, a current temperature, etc. For example, the user action deriving unit can be adapted to derive from a data indicating that it is currently late in the night as user activity that no subjects are present in an office room, wherein subjects are at the same time sleeping in the neighboring bedroom. The first and second baseline, for instance, for the office room and the bedroom, can then be determined accordingly, if the sensing goal refers, for example, to sleep monitoring.

In an embodiment, for determining the first and second baseline's receiving directions of radiofrequency signals received by the one or more network devices are determined and wherein the first and second baseline are determined based on the radiofrequency signals acquired from directions associated with the first and second sensing area, respectively. Preferably, for determining the second baseline, radiofrequency signal paths of acquired radiofrequency signals are determined that are influenced by events in the second sensing area, and wherein the second baseline is determined based on received radiofrequency signals associated with the determined radiofrequency signals paths. For example, if the radiofrequency signals refer to CSI radiofrequency signals each radiofrequency signal refers to a plurality of radiofrequency signal paths that can be differentiated. Accordingly, radiofrequency signal paths can be determined that can be influenced by events in the second sensing area, for instance, radiofrequency signal paths that are received from a direction of the second sensing area. The second baseline can then be determined based, preferably, only on radiofrequency signals associated with the radiofrequency signals paths influenced by events in the second sensing area. This determination of the second baseline allows for a very good differentiation between events in the first sensing area and events in the second sensing area.

In an embodiment, the first and second baseline are determined based on different signal characteristic ranges of the same received radiofrequency signals. Generally. signal characteristic ranges refer to ranges of possible values of signal characteristics. For example, the signal characteristics can refer, for instance, to a frequency, phase, or an amplitude of the signal. A range can generally also comprise several bands, wherein a band refers to a subrange within the range. Between the bands in some cases gaps can be defined of value ranges that are not part of the range. Thus, in some cases ca range can also be defined as an interrupted range, wherein an interruption of a ranges refers to values to belonging to the range. In a preferred example, for the first baseline and the second baseline different frequency ranges of received radiofrequency signals can be utilized. Moreover, for the first baseline, for instance, a higher amplitude range can be used, since it is expected that events in the first sensing area cause a higher signal than events in the second sensing area. Thus, for the second baseline a lower amplitude range than for the first baseline can be chosen as basis.

In an embodiment, the processing instructions refer to filtering out one of the first and/or second baseline from a radiofrequency signal received by the radiofrequency sensing network for differentiating between events originating from the first and second sensing area. For example, the filtering can be performed by subtracting the first and/or second baseline from the radiofrequency signal. Moreover, the filtering can for instance, also refer to a weighted filtering, in which certain signal parts of the first and second baseline are weighted more heavily than other parts of the first and/or second baseline and thus filtered out more strongly in the radiofrequency signal. For example, radiofrequency signal paths in the first baseline that are identified as coming from the second sensing area can be provided with a higher weight such that they are filtered out more strongly when applied to the radiofrequency signals. However, the filtering out can also refer to a more complex filtering, for instance, to a filtering that changes only one or more characteristics of the radiofrequency signal based on the first and/or second baseline. For example, if one of the baselines is indicative of, in particular, includes, a periodic movement, like the movement of a fan or other specific event, the filtering can be applied such that only this respective periodic movement indicated by the first and/or second baseline is filtered out from the radiofrequency signal. The filtered radiofrequency signal is then utilized, for instance, in the radiofrequency sensing algorithm to determine a result of the radiofrequency sensing.

In an embodiment, the configuration unit is further adapted to configure the functions of the radiofrequency sensing network with respect to a sensed event in the second sensing area based on a predetermined set of rules. For example, these predetermined set of rules can refer to the respective processing instructions mentioned above. However, the predetermined set of rules can also refer to a completely different set of rules. For example, the set of rules can refer to a logical set of rules that is applied after a result of the sensing is acquired for each sensing area. For example, the set of rules can refer, based on the respective baselines, to subtracting the results for the second sensing area from the result for the first sensing area to receive the correct result for the first sensing area. Moreover, the set of rules can also refer to security rules that indicate for instance, that the events sensed in the second sensing area are only to be used for correcting the event detection in the first sensing area, and that the events sensed in the second sensing area are not to be recorded. Such rules can be used, for instance, in cases in which the second sensing area does not belong to the owner of the network.

In a further aspect a network is presented, wherein the network comprises one or more network devices adapted to perform radiofrequency sensing, wherein the network is adapted to perform radiofrequency sensing in a first sensing area and a second sensing area separated by at least one physical separation, wherein the radiofrequency sensing of the network devices is configured to differentiate between events originating from a first and second sensing area based on a first baseline and a second baseline by an apparatus as described above.

In a further aspect of the present invention, a network is presented, wherein the network comprises one or more network devices adapted to perform radiofrequency sensing, and an apparatus as described above.

In a further aspect of the present invention, a method for configuring a radiofrequency sensing of a radiofrequency sensing network comprising one or more network devices configured to perform radiofrequency sensing is presented, wherein the network is adapted to perform radiofrequency sensing in a first sensing area and a second sensing area separated by at least one physical separation, wherein the method comprises a) determining a first baseline and a second baseline, wherein the first and second baselines are determined based on radiofrequency signals received by one or more network devices of the network, and wherein the first baseline is associated with the first sensing area and wherein the second baseline is associated with the second area and is determined such that it enables a radiofrequency sensing of events in the second sensing area by the network devices, b) configuring the radiofrequency sensing of the network devices to differentiate between events originating from the first and second sensing areas based on the first baseline and the second baseline.

In a further aspect of the present invention, a computer program product for configuring radiofrequency sensing of a radiofrequency sensing network is presented, wherein the computer program product comprises program code causing an apparatus as described above to execute a method as described above.

It shall be understood that the apparatus as described above, the network as described above, the method as described above and the computer program product as described above have similar and/or identical preferred embodiments, in particular as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described herein after.

### BRIEF DESCRIPTION OF THE DRAWINGS

In the following drawings:

FIG. 1 shows a schematically and exemplarily a system for configuring a radiofrequency sensing network in a first sensing area adjacent to a second sensing area,

FIG. 2 are a schematic representation of the different states of the first and second areas for determining the first and second baselines,

FIG. 3 shows the influence on a physical separation on radiofrequency signals in a radiofrequency sensing application, and

FIG. 4 shows a method to configure radio frequency sensing.

### DETAILED DESCRIPTION OF EMBODIMENTS

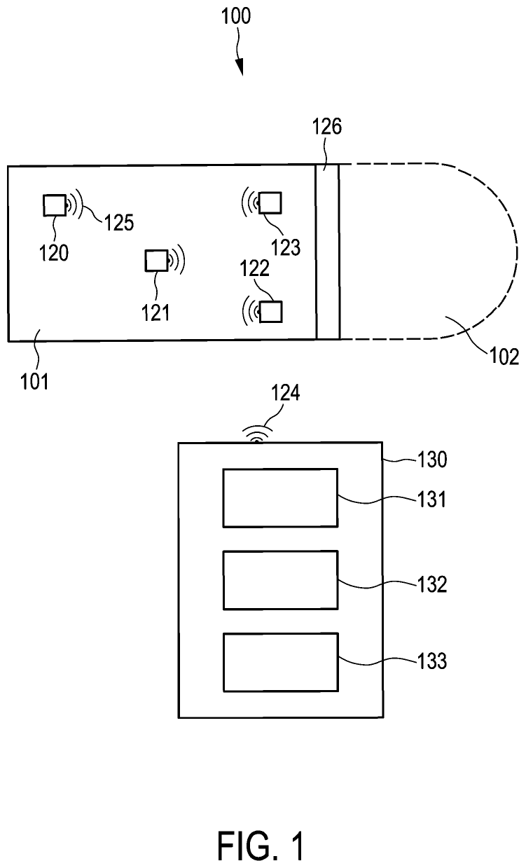

FIG. 1 shows an embodiment of a network 100 comprising an apparatus 130 for configuring a radiofrequency sensing of the radiofrequency sensing network to differentiate between events originating from a first 101 and a second sensing area 102. In an example shown in FIG. 1, the radiofrequency sensing network 100 is installed inside a house or room 101 and comprises one or more network devices 120, 121, 122, 123, wherein the network devices 120, 121, 122, 123, in this example, are installed within the house or room 101. The first sensing area 101 corresponds in this case substantially to the house or room 101 and the network devices 120, 121, 122, 123 are placed within the first sensing area 101. In this embodiment, the walls of the house or room 101 provide a physical separation 126 to the second area 102 outside the first area 101. The network devices 120, 121, 122, 123 comprise at least one antenna to receive radiofrequency signals. The apparatus 130 can be communicatively coupled to the network via a communication link 124 being, for instance, a wireless communication link. For example the apparatus can be communicatively coupled to the network to configure the radiofrequency sensing of the radiofrequency sensing network. Generally, the radiofrequency signals can originate from the radiofrequency background present within the environment. Alternatively, the radiofrequency signals can also be transmitted by one of the one or more network devices 120, 121, 122, 123, as indicated by the symbol 125. Moreover, the radiofrequency signals can also be generated by a specific device, which is configured to transmit the radiofrequency signals utilized for radiofrequency sensing of the network devices.

In the embodiment of FIG. 1, the network 100 comprises the apparatus 130. The apparatus 130 comprises a baseline determining unit 131, which is adapted to determine baselines for radio frequency sensing based on the radiofrequency signals received by the network devices of the network 100. The first baseline can be determined, for instance, when the first sensing area 101 and the second sensing area 102 are in a particular state with respect to a sensing goal. For example, the first sensing area 101, i.e. the inside of the house or room 101, can be in an empty state, and the second sensing area 102 outside the first sensing area can also be in an empty state with respect to a subject which presence should be determined as sensing goal. The first baseline can then be determined based on the radiofrequency signals received by the network devices 120, 121, 122, 123 during the respective state of the first 101 and second sensing area 102. For example, the received radiofrequency signals can be averaged and the baseline can then be determined based on the average. For example, an average amplitude can be used as baseline or the average amplitude can be increased with a predetermined value to take into account potential additional noise.

The second baseline can then be determined, for example, when the subject which presence should be determined as sensing goal, like a person, is present in the second sensing area 102, for example, a subject is present outside of the room or house. Further, when determining the second baseline, the first sensing area 101 is empty. In this exemplary embodiment, the presence of a person may introduce fluctuations into the received radiofrequency signals from the second sensing area 102. Since radiofrequency signals disturbed by the presence of a person outside the house or room 101, i.e., in the second sensing area, in this example, have to travel through the physical separation and are thus attenuated, the presence of a person in the second sensing area 102 introduces less fluctuations into the received radiofrequency signal than the presence of a person in the first sensing area, for example, inside the house or room 101. The second baselines is then determined based on the received radiofrequency signals in the second state, for instance, by also averaging the received radiofrequency signals. The second baseline may be determined based on the interaction of the received radio-frequency signals with the at least one physical separation 126, 330.

Accordingly, in this embodiment, the baselines are determined to represent stable situations for both cases, i.e. the first case corresponds to the state where both the first 101 and second sensing areas 102 are empty and the second state corresponds to the situation where the first area 101 is empty and the second sensing area 102 is occupied. Preferably, in such a case, the baselines are determined by adding a predetermined value to an average amplitude value measured during both stable situations.

In another example, the baseline determination unit 131 can be adapted to determine the first and second baseline based on received radiofrequency signals for the same physical state of the first 101 and second area 102, for example the empty state. Since the fluctuations introduced into the received radiofrequency signal are higher in case the first area is occupied than in case the second area is occupied, the first baseline can be determined as a value up to 20% above an average amplitude value of the signals received in the empty state. Since in this case a person outside or in the second sensing area only introduces fluctuations between 10% and 20% above the average value, the baseline determination unit 131 can be adapted to determine as second baseline the average amplitude signal of the received signals. Thus, when utilizing the first and second baseline for radiofrequency sensing, for instance, by only taking into account signals that lie above the respective threshold, for determining the presence of a subject in the first sensing area 101 only received radiofrequency signal fluctuations above the first baseline are considered. Whereas lower fluctuations can be taken into account utilizing the second baseline for determining a presence in the second sensing area. Therefore, the radiofrequency sensing network 100 configured as described in the present embodiment allows to differentiate between events in the first and second sensing areas.

In other embodiments, activities of subjects or other sensing goals detectable with radiofrequency signals can be considered. The baseline determination would then have to be in accordance with the parameters set by the chosen sensing goal or detection mode. For example, breathing detection is based on the analysis of signal characteristic different from the signal characteristics considered for presence detection.

The apparatus 130 further comprises a configuration unit 132 for configuring the network 100. In particular, the configuration unit 132 is adapted to configure the radiofrequency sensing of the network 100, for example the configuration unit 132 can be adapted to determine which radiofrequency sensing algorithm is used for radiofrequency sensing and how the first and second baselines are utilized in the radiofrequency sensing of the network 100 to differentiate between events originating in the first sensing area 101 and/or in the second sensing area 102.

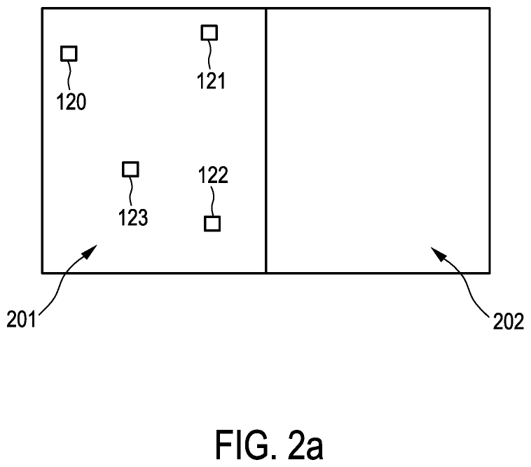

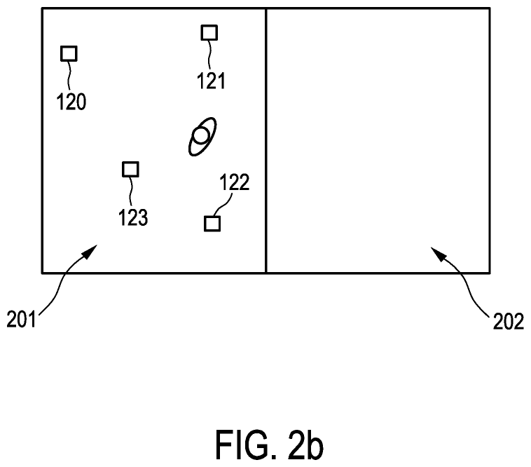

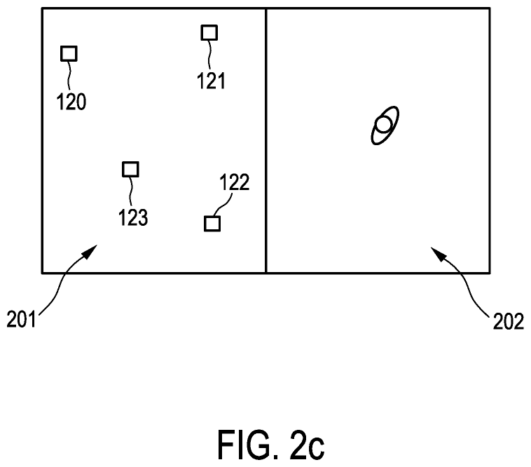

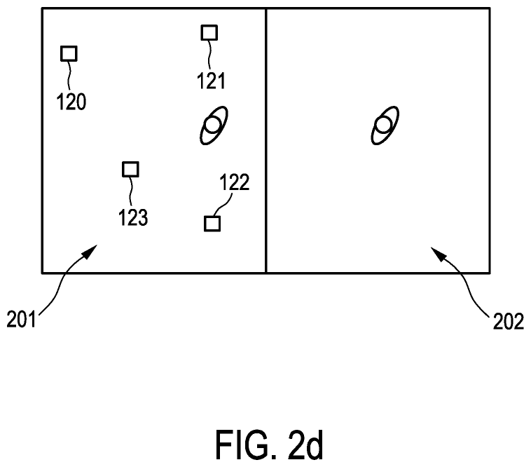

FIG. 2 show a more detailed example of the functions of the apparatus 100 for configuring the network 100 shown in FIG. 1. In this example, the first sensing area 201 corresponds to a first room and the second sensing area 202 corresponds to a second room 202 adjacent to the first room, wherein the network devices are inside the first room. The physical separation between the two rooms may be a wall or a wall having one or more doors or windows. FIG. 2a shows the state in which both rooms are empty, FIG. 2b shows the situation in which the first room is occupied and the second room is empty, FIG. 2c shows the situation in which the first room is empty and the second room is occupied, and FIG. 2d shows the situation in which both rooms are occupied. In this embodiment, configuration of the system may be done with respect to the occupation or presence of persons inside the different areas as described above. However in this example, the apparatus 130 further comprises optional user interface unit 133 that can comprise or communicate with a user interface that, during configuration, can prompt the user to fulfil certain conditions. These conditions may refer to the states of the first and second sensing areas. For example, the configuration could start with the situation that both rooms are empty. The user could confirm that both rooms are empty via the user interface unit 133. Alternatively, the user could confirm that the sensing areas have been empty for a specific time that he could indicate or that the two sensing areas will be empty for a specific time that he could indicate. Further, the user interface unit could use GPS tracking of user devices or WiFi devices recognized by their radiofrequency signals to identify whether one of the areas is empty or not. In the described scenario, the baseline determination unit 131 can then determine the first baseline when the state is such that both rooms are empty. For example, the system could determine the average value of radiofrequency signals and then set the baseline to a value above the average value by a specified percentage, wherein the percentage can be determined such that the presence of a person in this area normally introduces disturbances of the radio frequency signals above this value. However, the user interface unit 133 can also be adapted to prompt the user to occupy one of the areas and measure the disturbance with respect to the previously determined average value and then determine the specific percentage based on the measured disturbance.

In a next step, the user interface unit 133 can indicate to a user that only the first sensing area 101 should be empty and the second sensing area 102 should be occupied. The user can then confirm whether this situation was fulfilled at some specified time or will be fulfilled or simply confirm that the situation is present. This again allows the baseline determination unit 131 to determine the average value or the actual value in this particular situation. However, the interface unit 133 can also be adapted to prompt the user to occupy the first sensing area 101 and to ensure that the second sensing area 102 is empty and then accordingly measure the impact of the presence of a person in the first area on the received radiofrequency signal. Moreover, the baseline determination unit 131 can also be adapted to determine the second baseline in a situation in which both sensing areas are occupied. After these configuration steps, the baseline determination unit 131 has determined the first and second baseline in accordance with one of the above described possibilities. For example, the first baselines then corresponds to the background signal caused by any kind of radiofrequency signals in the first 101 and second area 102.

The configuration unit 132 can then be adapted to configure the radiofrequency sensing such that based on the determined first and second baseline the radiofrequency sensing can differentiate between events in the first 101 and second sensing area 102. For example, the configuration unit 132 can be adapted to configure the radiofrequency sensing such that first received radiofrequency signals are compared with the first baseline to determine if a person is present in one of the first and second area. If it is determined that a person is likely present in one of the areas, the radiofrequency sensing can then be configured to compare the received radiofrequency signals with the second baseline to determine if the received signals are similar to signals caused by a person present in the second sensing area 102. If this is the case, the radiofrequency sensing result can refer to the detection of a person in the second area 102 but not in the first sensing area 101.

Accordingly, the radiofrequency sensing can be configured based on accordingly determined baselines to derive the influence of other events, such a breathing or fall detection in a similar manner. In another embodiment, it can be advantageous to also determine the influence of more than one person present in the sensing area. Moreover, first and second baselined can also be determined with one person in the first area 101 or one person in the second area 102 or one person and another person in the first area 101 and two persons in the second area 102 or any combination thereof. Further, the number of persons could be increased by steps of one, and the baselines determined based on these measurements to be also indicative of the influence of a respective number of persons present inside the sensing areas.

In the following further preferred embodiments will be described in more detail. In a normal radiofrequency sensing configuration, one is normally interested in events happening inside a configured first sensing area, which may be an internal area only. However, as the wireless signals are not spatially confined with clear boundaries, the radiofrequency signals received in the first sensing area may be the results of events outside the configured first sensing area of interest. In particular, the outside of the first sensing area can thus be regarded as a second sensing area outside the first sensing area. Hence, activities outside of the first sensing area, i.e. the area of interest, can impact the detection performance, causing, for example, a false positive trigger. However, in the present invention these disturbances from outside of the first sensing area are intentionally utilized for provide additional interesting insights. In situations when there is a clear physical separation, e.g. a wall, between the first and second area, the invention is based on utilizing next to the first standard baseline a second, external, sensing profile, i.e. a second baseline, to distinguish between events originating from the internal vs the external area, i.e. the first vs the second sending area. Thus, a goal of the is invention is that not a new; separate radiofrequency sensing group addressing the second, external, area is defined, but rather that the measurements already taken by the existing radiofrequency sensing group, which preferably is for monitoring the inside of a room, are re-used for the exterior monitoring by utilizing a different baseline. Utilizing a specific additional baseline tailored to detecting external activities, i.e. activities in the second sensing area, will both improve the sensing reliability of the first sensing area as well as enabling the definition of an external second sensing area without creating any additional sensing overhead on the network.

Generally, a radiofrequency sensing system is using the effect of changes in transmitted radiofrequency signals in its environment. At the receiving side, the received radiofrequency signal strength, and for example other signal quality related properties, such as CSI for Wi-Fi, from the source may vary depending on absorption, reflection, diffraction and scattering of the transmitted signal. Changes in the received radiofrequency signals can be caused by moving objects in or near a sensing area. A preferred radiofrequency sensing system, i.e. network, consists of several radiofrequency sensing devices, network devices, that preferably define a first sensing area. Within that first sensing area the sensing will be performed to detect, for instance, motion or presence of a person, or breathing and fall detection, etc. However, the radiofrequency signals will also go through most physical separations confining the first sensing area, wherein there will be an attenuation on the signal strength and/or modifications to other parameters or characteristics of the respective radiofrequency signal. e.g. phase shifts on CSI. Depending on the material thickness and orientation of the physical separation the variations can differ. When the radiofrequency signals are used for communication between network devices, the variations are however of no importance as in most cases the radio transmit power is configured to allow for a good data reception also in other rooms, i.e. despite the aforementioned variations the signals are still well readable by a receiver. This also means for radiofrequency signal measurements that signals can go through a wall and can come back if they find signal reflections on other objects beyond the wall or are received by radiofrequency nodes at the other side of the wall. However, the specific wireless signals that first leave the room and return through the wall back again into the room will be usable for sensing in the external area but will also affect the motion sensing algorithm within the internal area. Generally, in case the transmitting and/or receiving radiofrequency sensing devices, i.e. network devices, are located rather close to such a physical separation, like a wall, the impact of the signals that go out and return will be higher on the radiofrequency sensing than when a network device is further away from the physical separation. Depending on the use-case, the external signal can be a desired source of extra information or an undesired annoyance. Hence, for example, the configuration unit can, during the initial setup of the sensing area, be adapted to utilize a predetermined selection criterion to decide whether to include or exclude radiofrequency signals originating and/or received by network devices close to the physical separation in the radiofrequency sensing of the network, especially when the application demands that the sensing can distinguish well between sensing events within the two separated areas. Generally, also it is often referred to the physical separation as “wall” throughout the application, the physical separation can also refer to doors, windows, ceilings, floors, cubicle dividers, large pieces of furniture and other separations between areas.

Generally in radiofrequency sensing baselines are used to identify motion, presence or other events, like breathing patterns or falls occurring in a defined first sensing area. In the present invention it is proposed to introduce a specific additional baseline, i.e. second baseline, for detecting events in a second sensing area, on another side of the physical separation and employ the second baseline to better differentiate whether a certain event has taken place in the first sensing area or in the second sensing area. The second baseline may be determined based on the interaction of the received radio-frequency signals with the at least one physical separation 126, 330.

As explained above, radiofrequency sensing devices, i.e. network devices, also receive transmitted radiofrequency signals, which are bounced back from an area outside, e.g. external, to a configured first sensing area. The bounced back signals can impact the detection related to the first sensing area, which, preferably, is an internal area. This effect can be either desired or undesired or both. For example, an undesired effect could be that a person present in the second sensing area may wrongfully be detected by the network as being in the first sensing area. This yields a false positive, as the detected motion has not been in the first sensing area. This can be particularly annoying in e.g. apartment buildings, as there can be many overlapping walls shared with neighbors, leading to multiple sources of false positives. In addition, from a privacy perspective, it is undesired that in absence of the user, the network starts detecting and logging activity in the neighbor's apartment. From privacy point of view; it is highly desirable that any such detections are ignored and hidden as early as possible in the processing flow. An example for a desired effect can be that under certain circumstances, the user is interested in what is happening in the second sensing area. This can be the case in e.g. getting an early indication of motion happening outside an area before the motion trajectory progresses to the inside of the room, for instance, to insure lower latency or a burglar in the garden being detected before they have a chance to reach/damage the house.

In the following some examples of a configuration of the radiofrequency sensing of the network based on the first and second baseline will be provided. One or more of these configurations are preferably stored, for instance, in form of respective rules on a storage and can be accessed by the configuration unit, wherein the configuration unit can then be adapted to utilize the rules for configuring the radiofrequency sensing accordingly.

For example, in an application case, in which there is no interest to detect events in the second sensing area, the configuration unit can be adapted, for instance, to configure the radiofrequency sensing such that the second baseline is used to filter out potential false positive events originating from interactions of the radiofrequency signals with subjects in the second area. This can improve the detection performance, e.g. less false positives, for the first sensing area since the system is able to not mistake an event in the second sensing area for an event in the first sensing area.

In an example, in which there is also an interest to get more insights on what is happening in the adjacent second sensing area, the configuration unit can be adapted, for instance, to configure the radiofrequency sensing such that the second baseline is used to differentiate between first and second area events. Preferably, for preforming radiofrequency sensing in the two sensing areas the same radiofrequency sensing setup, i.e. the same network device, are used such that an introducing of extra wireless traffic can be avoided. In an example, the same network device or a subset of the network device may be used to determine the second baseline based on the interaction of the received radio-frequency signals with the at least one physical separation 126, 330. The use of the first and the second baseline may be used to differentiate between the first and the second area.

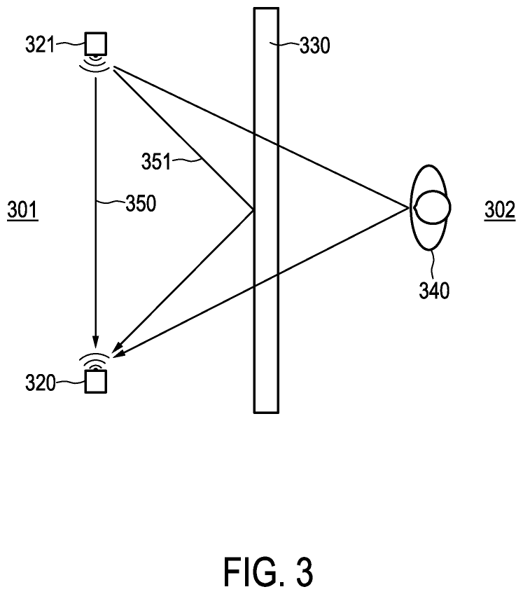

FIG. 3 shows the influence of a physical separation on radiofrequency signals. The network devices 321, 320 are in the first sensing area 301. The physical separation 330 separates the first sensing area 301 and the second sensing area 302. A person 340 is present in the second sensing area 302. The figure shows that each wireless multipath signal between a transmitting and receiving network device is unique, however, the absorption caused by the wall in both directions has a very distinct effect on signals compared to free air transmission. For example, the direct path 350 is only influenced by the absorption caused by the air between network device 320 and network device 321, whereas the signal on the reflected path 351 has a longer runtime due to the longer path length and will change in phase and signal strength due to the reflection on the wall surface. Further, the absorbed path, which goes through the wall and is reflected by the person 340 and then goes through the wall a second time and is only then received by the network device 320 is the most attenuated signal path. In particular, this signal has the longest runtime and is absorbed twice by the wall. Thus this signal undergoes at least four direction and/or phase changes due to the change in refractive index and is also influenced by the reflection by the person 340. Therefore, even in a scenario where no person or activity to be sensed is present in either one of the areas, the different signal paths, which occur due to the presence of the physical separation, can be identified and measured. Therefore, in an embodiment the apparatus allows to configure the radiofrequency sensing of the network such that it is possible to detect whether the person 340 is present in the first 301 or second sensing area 302 by identifying the respective multipath of the signal. In the example shown in FIG. 3, the multipath signal that corresponds to the signal that is absorbed twice by the wall also includes the signature of a person 340 moving, such that the radiofrequency sensing of the network can be configured in this case to associate the moving person 340 with the second sensing area 302. Moreover, also other effects can be taken into account, for instance, the material of the physical separation can lead to a lensing of wireless signal, in particular, in case of direct 60 GHz signals. Under certain circumstances, a radiofrequency signal can also only go once through the physical separation. For example, if the physical separation refers to a room divider or furniture, the return path from an interaction on the other side of the physical separation to a network device can actually not be obstructed by the same or any physical separation. In this single-pass case, the absorption will be reduced compared to the dual-pass case. Also such special cases can therefore be distinguished and taken into account when determining and utilizing the two baselines.

In a preferred embodiment, the invention is applicable to a radiofrequency sensing network with radiofrequency sensing capable network devices forming a first sensing area 301. Further, in addition to the first sensing area 301 a corresponding second sensing area 302 can be defined on the other side of a physical separation 330. The apparatus 130 is the adapted to determine a first baseline and a second baseline each corresponding to a respective sensing area, wherein for the determination and also for the radiofrequency sensing it is preferred that the same radiofrequency sensing signals and sensing data are utilized. Furthermore, for the second baseline the same radiofrequency sensing signals are impacted by the interaction of the radiofrequency signals with the with the at least one physical separation 126, 330. The radiofrequency sensing can then be configured to apply a filter to exclude/differentiate external events from internal events, events in the two different sensing areas.

In a preferred embodiment the configuration apparatus 130 is utilized during a configuration period of the radiofrequency sensing of a network 100, for instance, during a setup of the network 100. However, the configuration apparatus can also be utilized after the setup of the network, for instance, when changes have occurred in the environment of the network. In particular, during a configuration, after a selecting and configuring of the most suited network devices that should participate in the radiofrequency sensing task of the network, in a next step the baseline determination unit can be utilized to prepare the two baselines for the two sensing areas. In particular, a first baseline is determined for the first sensing area of the configured network devices and a second baseline for the second sensing area of the configured network devices. In an example, the second baseline can be determined such that it is only based on a subset of multipaths of the received radiofrequency signals, preferably, those multipaths that are compared with all received multipaths most strongly influenced by events in the second sensing area. Additionally or alternatively, the second baseline can be determined such that it is associated with a different sub-set of wireless sensing frequencies than the first baseline, e.g. only the 2.4 GHz signals can be utilized for determining the second baseline since these allow for a better penetration of physical separations, while 5 GHZ signals are ignored. Further, the determination of the second baseline can also be based on a subset of the directionalities of the radiofrequency signals transmitted by a network device, e.g. when directional WiFi is used, only signals from a subset of antennas at network device can be utilized. However, it is preferred that for determining both baselines radiofrequency signals from the same set of network devices are used. Generally, the two initial baselines can be determined based on signals received during a walk test across both the first and second sensing area.

The baseline determination unit can be adapted to create baselines from signals received at moments when a predetermined confidence is given that at that moment a desired state is or was present, for instance, that there is or was no one in the first sensing area, e.g. during an “away’ period indicated by the GPS of the user's phone. The network can then learn based on the determined baseline to classify such events as external motion and as such identify them as a false positive for the first sensing area. Further, doing a walk test in the second sensing area may or may not be possible, for instance, if the second sensing area is the neighbor's apartment. In this situation, the baseline determination unit can be adapted to determine the second baseline, for instance, from signals received whenever the user is not at home or not in proximity of the first sensing area. Thus, in this case a first baseline is determined that is indicative for a state in which both areas are “empty”, and a second baseline is indicative for a state in which the first sensing area is “empty”, but presence/motion is detectable in the second sensing area. The baseline determination unit can be adapted to utilize heuristics to decide which baseline is associated with the second sensing rea, e.g. a long-term baseline determined from signals received at night is assumed to describe a situation without presence/motion in the second sensing area.

Subsequently, the configuration unit is adapted to configure the radiofrequency sensing of the network, in particular, to determine which actions the radiofrequency sensing performs when events are detected that might be linked to the second sensing area. For example, as default configuration, the second baseline can be used to filter out multi-path signal components that might be influenced by the second sensing area in order to improve the reliability of the sensing in the first sensing area. However, if user decides to make use of the second sensing area, the configuration unit can also be adapted to configure the radiofrequency sensing to utilize an according filtering with the first baseline to enable such sensing in the second sensing area. For example, the sensing in the second sensing area can be used for reducing latency of the detection area or detect an unexpected guest in the garden.

On the other hand, if this external second sensing area belongs to another person's private area, e.g. neighbor's apartment, the configuration unit can be adapted to receive respective information and to configure the radiofrequency sensing to ignore radiofrequency signal distortions from the second sensing area in order to not have false positives in the first sensing area and to not log the events in any way in view of privacy concerns/issues/regulations. Optionally, the configuration unit can be adapted to configure the radiofrequency sensing to employ motion trails to discern that the second sensing area is not associated with the apartment of the user, for example, when there is never a continuous motion trail from the second sensing area to the first sensing area, indicating that the two areas are not interconnected. The motion trail analytics may be performed automatically and subsequently the configuration unit can be adapted to auto-select configuration rules regarding external sensing events.

The configuration of the network as described in any of the embodiments above can be applied to a plurality of application areas/use-cases. For example, for terraced houses or semidetached houses, the configuration utilizing the additional baseline enables to exclude detections of undesired events from an adjacent house, such that internal false positives are prevented. Also in houses located close to a public pathway the configuration allows to enable to exclude the detection of undesired events from that public pathway, to prevent internal false positives. Moreover, for apartments with a common gallery, the configuration allows to exclude undesired events from the gallery. Furthermore, for houses with adjacent garden or a patio, a motion or presence in the garden/patio can be detected from indoor network devices without providing extra network devices being required. In this case, the indoor network devices can thus be used to complement other presence/motions sensors in the external area.

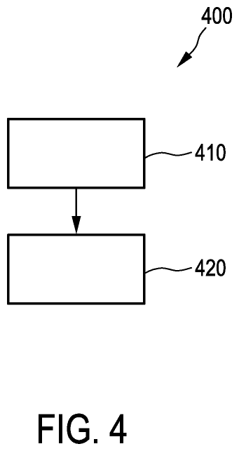

FIG. 4 shows an exemplary flow chart of a method 400 for configuring a radiofrequency sensing of a radiofrequency sensing network, like the network 100. The method 400 comprises a step 410 of determining a first baseline and a second baseline, wherein the first and second baselines are determined based on radiofrequency signals received by one or more network devices of the network. The first baseline is associated with the first sensing area and the second baseline is associated with the second area and is determined such that it enables a radiofrequency sensing of events in the second sensing area by the network devices. This step 410 can be performed, for instance, by the baseline determination unit 131 as described above. Further the method 400 comprises a step 420 of configuring the radiofrequency sensing of the network devices to differentiate between events originating from the first and second sensing areas based on the first baseline and the second baseline. This step 420 can be performed, for instance, by the configuration unit 132 as described above.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfil the functions of several items recited in the claims. The mere fact that certain measures are recited in mutually different dependent claims does not indicate that a combination of these measures cannot be used to advantage.

Procedures like the determining of the baseline, the configuring of the radiofrequency sensing, et cetera, performed by one or several units or devices can be performed by any other number of units or devices. These procedures can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention refers to an apparatus for configuring a radiofrequency sensing of a radiofrequency sensing network comprising network devices, e.g. luminaires, wherein the network is adapted to perform radiofrequency sensing in a first and second area separated by a physical separation. The apparatus comprises a providing unit determining a first baseline and a second baseline, wherein the first/second baseline is associated with the first/second area, respectively. The first/second baseline enable a radiofrequency sensing of events in the second area by the network devices. A configuration unit is adapted to configure the radiofrequency sensing to differentiate between events originating from the areas based on the baselines. This allows the present invention to provide an apparatus that allows for a more accurate and reliable radiofrequency sensing in a predefined sensing area.

1. An apparatus for configuring a radiofrequency sensing of a radiofrequency sensing network comprising one or more network devices configured to perform radiofrequency sensing, wherein the network is adapted to perform radiofrequency sensing in a first sensing area and a second sensing area separated by at least one physical separation, wherein the apparatus comprises:
a baseline determining unit for determining a first baseline and a second baseline, wherein the first and the second baselines are determined based on radio-frequency signals received by one or more network devices of the network, wherein the second baseline is determined based on the interaction of the received radio-frequency signals with the at least one physical separation, and wherein the first baseline is associated with the first sensing area and wherein the second baseline is associated with the second area and is determined such that it enables a radiofrequency sensing of events in the second sensing area by the network devices,
a configuration unit adapted to configure the radiofrequency sensing of the network devices to differentiate between events originating from the first and second sensing area based on the first baseline and the second baseline;
wherein the first baseline is determined based on radiofrequency signals received when the first sensing area and the second sensing area are both in the same state with respect to a sensing goal of the radiofrequency sensing performed by the network devices, and wherein the second baseline is determined based on radiofrequency signals received when the first sensing area and the second sensing area are in different states with respect to a sensing goal of the radiofrequency sensing performed by the network devices.

2. (canceled)

3. The apparatus according to claim 1, wherein the sensing goal refers to a presence/absence or activity detection of subjects in the first and second area, wherein the state of the first and second sensing area when receiving the radiofrequency signals utilized for determining the first baseline refers to a state in which subjects are absent or not active in the first and second area, respectively.

4. The apparatus according to claim 3, wherein the sensing goal refers to a presence/absence or activity detection of subjects in the first and second area, wherein the state of the first and second sensing area when receiving the radiofrequency signals utilized for determining the second baseline refers to a state in which subjects are absent or inactive in the first and present or active in the second area, respectively.

5. The apparatus according to claim 1, wherein the apparatus comprises a user interface unit, wherein the user interface unit is adapted to provide instructions to a user with respect to the performing of specified actions in the first area and the second area, wherein the first and second baseline are determined based on radiofrequency signals received by one or more of the network devices of the network when the user performs the actions indicated by the instructions.

6. The apparatus according to claim 1, wherein for determining the second baseline, radiofrequency signal paths of acquired radiofrequency signals are determined that are influenced by events in the second sensing area, and wherein the second baseline is determined based on received radiofrequency signals associated with the determined radiofrequency signals paths.

7. The apparatus according to claim 1, wherein the first and second baseline are determined based on different signal characteristic ranges of the same received radiofrequency signals.

8. The apparatus according to claim 1, wherein for determining the first and second baseline receiving directions for radiofrequency signals received by the one or more network devices are determined and wherein the first and second baseline are determined based on the radiofrequency signals acquired from directions associated with the first and second sensing area, respectively.

9. The apparatus according to claim 1, wherein the first and second baseline are determined based on the same received radiofrequency signals.

10. The apparatus according to claim 1, wherein the configuration unit is adapted to configure the radiofrequency sensing such that the differentiation between events originating from the first and second area is based on processing instructions with respect to a processing of radiofrequency signals acquired by one of the network devices of the network during a radiofrequency sensing utilizing the first and second baseline.

11. The apparatus according to claim 10, wherein the processing instructions refer to filtering out one of the first and/or second baseline from a radiofrequency signal received by the radiofrequency sensing network for differentiating between events originating from the first and second sensing area.

12. The apparatus according to claim 1, wherein the configuration unit is further adapted to configure the functions of the radiofrequency sensing network with respect to a sensed event in the second sensing area based on a predetermined set of rules.

13. A network comprising one or more network devices adapted to perform radiofrequency sensing, wherein the network is adapted to perform radiofrequency sensing in a first sensing area and a second sensing area separated by at least one physical separation wherein the radiofrequency sensing of the network devices is configured to differentiate between events originating from a first and second sensing area based on a first baseline and a second baseline by an apparatus according to claim 1.

14. A method for configuring a radiofrequency sensing of a radiofrequency sensing network comprising one or more network devices configured to perform radiofrequency sensing, wherein the network is adapted to perform radiofrequency sensing in a first sensing area and a second sensing area separated by at least one physical separation, wherein the method comprises:
determining a first baseline and a second baseline, wherein the first and the second baselines are determined based on radiofrequency signals received by one or more network devices of the network, wherein the second baseline is determined based on the interaction of the received radio-frequency signals with the at least one physical separation physical separation, and wherein the first baseline is associated with the first sensing area and wherein the second baseline is associated with the second area and is determined such that it enables a radiofrequency sensing of events in the second sensing area by the network devices,
configuring the radiofrequency sensing of the network devices to differentiate between events originating from the first and second sensing area based on the first baseline and the second baseline;
wherein the first baseline is determined based on radiofrequency signals received when the first sensing area and the second sensing area are both in the same state with respect to a sensing goal of the radiofrequency sensing performed by the network devices, and wherein the second baseline is determined based on radiofrequency signals received when the first sensing area and the second sensing area are in different states with respect to a sensing goal of the radiofrequency sensing performed by the network devices.

15. Computer program product for configuring a radiofrequency sensing of a radiofrequency sensing network, wherein the computer program product comprises program code means causing an apparatus according to claim 1.
